(19) United States
(12) Patent Application Publication
(10) Pub. No.: US 2006/0099977 A1
(43) Pub. Date: May 11, 2006

(54) Method of mobile phone remote setup by utilizing SMS

(75) Inventors: Cheng-Shing Lai, Taipei (TW); Bo Zhao, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/166,163

(22) Filed: Jun. 27, 2005

(30) Foreign Application Priority Data
Nov. 11, 2004 (TW) 093134474

(51) Int. Cl. H04Q 7/20

(52) U.S. Cl. 455/466

(57) ABSTRACT

A method of mobile phone remote setup by utilizing SMS, which enables a mobile phone to send a normal SMS message, comprising a remote control function including a series of characters in a remote control selection and corresponding installation parameters, in the form of protocol data units (PDUs) through wireless communication network to another mobile phone for remote control functions. The method comprises the steps of decoding said SMS message in accordance with the PDUs while said SMS message being received by said another mobile phone; and implementing a remote control setup procedure corresponding to said remote control function being received by said another mobile phone and then sending a success or failure message back to said mobile phone.

### FIELD OF THE INVENTION

This invention relates generally to a method of mobile phone remote setup for functions including call forward, power off and message password checking, more specifically to a method of utilizing Short Message Service (SMS) function of a mobile phone to proceed with remote control functions including call forward, power off and message password checking for another mobile phone, enabling the mobile phone to quickly send a normal SMS message comprising a series of special characters and corresponding installation parameters out to the another mobile phone and achieve the object of remotely controlling the another mobile phone. Thus, according to the present invention, the another mobile phone won't cause interference to others and the privacy and security of the owner of the another mobile phone won't be easily disclosed to others.

### DESCRIPTION OF THE PRIOR ART

Heretofore, it is known that in nowadays knowledge and messages explode, message exchange and communication among people is getting more and more important, by the coming of network era, mobile communication and wireless communication . . . . Network and communication technologies spread widely and advance rapidly; as modern advanced communication tool, wireless devices become more and more significant among routine jobs and life, and irreplaceable. The functions of Short Message Service (SMS) with the advantages are friendly, rapid and convenient for not only a voice exchange tool but also communication tool . . . .

Along with the advancing of electronic industry, various kinds of electronic products, such as Global System for Mobile Communication (GSM) . . . consumer electronic products roll out one after another; the physical size becomes smaller, the cost lowers, the expensive wireless and network services now become easy to access and a very important part of daily life and work.

However, it is believed many people leave their mobile phones and forget to bring them along in power-on condition, such as the mobile phone are a home and go for work, or phones are left in the office and at home, at the moment, if someone calls, then users cannot answer the phones; the continues ringing might interfere others around, the callers might keep calling and thinking the users might not hear the ringing such might take time and cause misunderstanding; the screen of the mobile phone shows messages sent, users' privacy and security might disclose.

Under these kinds of condition, users can either ask people around the phone to transfer or turn off the phone, or nothing can be done, such might cause great inconvenience to users. This inventor noticed the problems and to fulfill the market demands, and studied the remote control of mobile phones by short messages to offer more competition among similar products in the market.

### SUMMARY OF THE INVENTION

Based on conditions described above, people often leave mobile phone with power on status and forget to bring it along. The phones cannot be answered when someone calls, the continues ringing of the phone might hinder others around, and the privacy and security of the owner of the mobile phone might be disclosed due to displaying the messages being received on the screen of the mobile phone. Therefore, in order to comply with market's needs and user's practical requirements and solve the problems described above, the inventor went through long period of study and experiment, finally developed the present invention to solve problems described above.

It is therefore a primary object of the invention to provide a mobile phone remote setup by utilizing SMS that solves problems described above also with following advantages:
1. Users send out a SMS message through wireless communication network to a power-on mobile phone via another mobile phone for remote control functions; the remote control functions include call forward, power off, mute and message password checking.
2. The remote control functions in a remote control selection can be added or erased by user, namely, user can modify the combination of the characters of the remote control functions. It's easier for user to memorize and avoid being harassed.

The above and other objects, features and advantages of the present invention will become apparent from the following detailed description taken with the accompanying drawings.

### BRIEF DESCRIPTION OF THE DRAWINGS

FIG. 1 is a block diagram of the present invention;

FIG. 2 is a flow chart of the present invention.

### DETAILED DESCRIPTION OF THE PREFERRED EMBODIMENTS

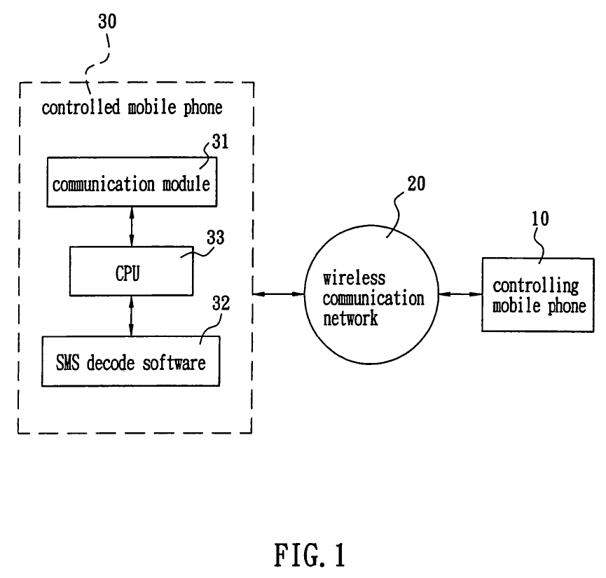

Referring to FIG. 1, the present invention enables a mobile phone 10 to send out a SMS message through wireless communication network 20 to another power-on mobile phone 30 for remotely controlling functions, such as call forward, power off, mute and message password checking, wherein the message comprises a series of special characters of remote control functions and corresponding installation parameters and is sent out in the form of protocol data units (PDU). When the another mobile phone 30 (or the controlled mobile phone 30) receives the message, it decodes the message in accordance with the PDUs, and processes one of the remote control setup procedures for call forward, power off and message password checking in accordance with the characters of the remote control function contained in the SMS message. Thus, a user can remotely control the another mobile phone 30 through the mobile phone 10 (or the controlling mobile phone 10) for activating the functions of call forward, power off and message password checking.

Referring to FIG. 1, the another mobile phone 30 comprises a communication module 31 for communicating with the mobile phone 10 via the wireless communication network 20, a SMS decode software 32 for decoding a SMS message being received and a CPU 33 for controlling all parts of the another mobile phone 30 in normal operation.

After the another mobile phone 30 described above receives a SMS message, it decodes the SMS message in accordance with the PDUs and checks whether the content of the SMS message matches the character string of one of the remote control functions in a remote control selection, and then checks if parameters are valid; if the content of the SMS message matches the character string of a remote control function and the parameters are valid, the another mobile phone 30 enters an automatic remote control setup procedure for the remote control function of call forward, power off or message password checking etc., then sends a success or failure message back to the mobile phone 10, whereby the remote control of said another mobile phone by said mobile phone is set up; if the controlling mobile phone 10 is power off, then no message will be sent back; if the content of the SMS message do not match the character string of a remote control function, then the controlled mobile phone 30 processes the SMS message in a regular way; if the parameters are invalid, the controlled mobile phone 30 sends a message of error parameter installation back to the controlling mobile phone 10.

The remote control functions in the remote control selection can be added or erased by the user, and the user can modify the combination of the characters of the remote control functions in order for being easily memorized by the user and avoiding being harassed.

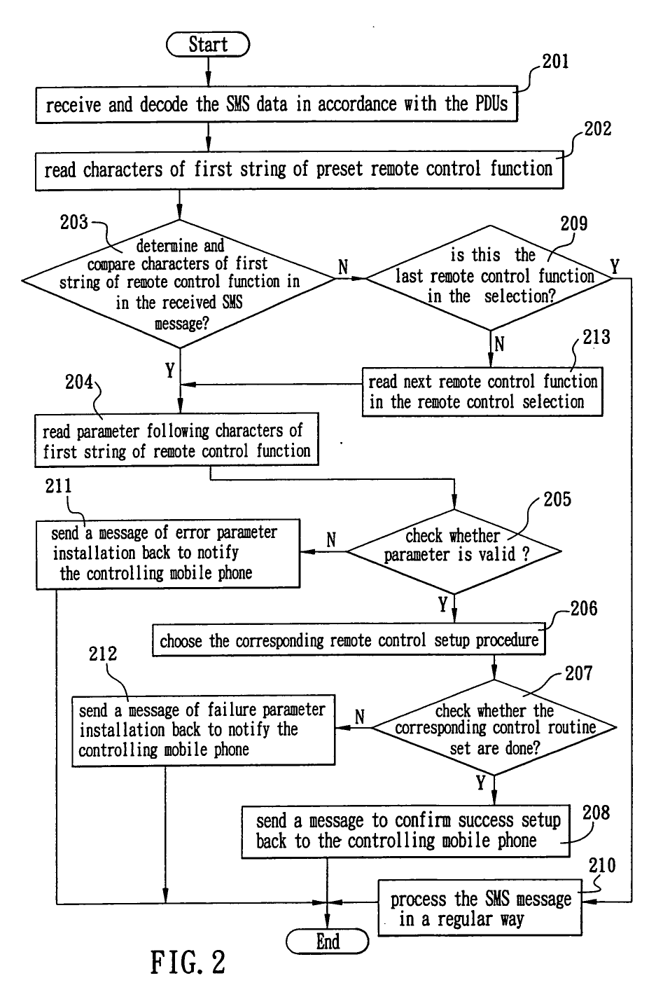

Following is the description of the interactive actions between the controlling mobile phone 10 and the controlled mobile phone 30; referring to FIG. 2, when the controlled mobile phone 30 receives the SMS message sent by the controlling mobile phone 10, the controlled mobile phone 30 will carry out the process comprising the following steps:

Step 201: receive and decode the SMS data sent by the controlling phone 10 in accordance with the PDUs through the wireless communication network 20;

Step 202: read characters of first string of the remote control function preset by the user; such [INCLDZY] refers to the function of call forward, [INCPOWEROFF] refers to the function of power off, or [INCPASSWORDON] refers to the function of message password checking, etc.

Step 203: determine and compare whether the characters of the first string contained in the SMS message (for example: user can set a space as the character of the first string) match the characters of one of the current remote control functions; if yes, then go to next step 204; otherwise, go to step 209;

Step 204: read the parameter following the characters of the first string, that is one of the remote control parameters, such as [INCLDZY 02587654321] and [INCPASSWORDON abcd abcd], wherein “INCLDZY” represents the characters of the remote control function for call forward and “02587654321” is a set of parameter for number of call forward, and “INCPASSWORDON” represents the characters of the remote control function for message password checking and “abcd abcd” is a set of parameter for message password checking and its password is “abcd”;

Step 205: check whether parameters are valid, according to the characters of the remote control functions in the remote control selection (for example: call forward parameters must be numbers), if yes, go to next step 206, if not, then go to step 211;

Step 206: choose and implement the corresponding remote control setup procedure;

Step 207: check whether the corresponding remote control setup procedure is done, if yes, go to step 208, if not, then go to step 212;

Step 208: send a message to confirm the success of the setting up back to the controlling mobile phone 10 and end up the process.

Step 209: determine whether this is the last remote control function in the remote control selection, if yes, go to step 210, if not, then go to step 213;

Step 210: process the SMS message in a regular way and end up the process.

Step 211: send a message of error parameter installation back to notify the controlling mobile phone 10 and then end up the process.

Step 212: send a message of failure parameter installation to notify the controlling mobile phone 10 and then end up the process.

Step 213: read the next remote control function in the remote control selection and return to step 204.

If the remote control function of power off is triggered, then no message is sent back to the controlling mobile phone 10.

While a preferred embodiment of the invention has been shown and described in detail, it will be readily understood and appreciated that numerous omissions, changes and additions may be made without departing from the spirit and scope of the invention.

What is claimed is:

1. A method of mobile phone remote setup by utilizing SMS, comprising the steps of:
sending, from a mobile phone, a SMS message in the form of PDUs through a wireless communication network to another mobile phone for activating remote control functions, said SMS message comprising one of remote control functions in a remote control selection in a series of characters, and corresponding installation parameters;
decoding said SMS message in accordance with the PDUs while said SMS message being received by said another mobile phone;
implementing a remote control setup procedure corresponding to said remote control function being received by said another mobile phone and then sending a success or failure message from said another mobile phone back to said mobile phone, whereby the remote control of said another mobile phone by said mobile phone is set up.

2. The method as recited in claim 1, wherein said another mobile phone comprises a communication module for communicating with said mobile phone, an SMS decode software for decoding said SMS message and a CPU to control all parts thereof in normal operation.

3. The method as recited in claim 1, wherein said remote control functions in said remote control selection can be added or erased, and combination of said characters thereof can be modified.

4. The method as recited in claim 1, wherein the said remote control functions include functions of call forward, power off and message password checking.

5. The method as recited in claim 2, wherein, while said another mobile phone receives said SMS message sent by said mobile phone, said another mobile phone proceeds with the steps of:
receiving and decoding said SMS message in accordance with the PDUs through the wireless communication network;
reading characters of first string of remote control function contained in said SMS message;
determining and comparing whether said characters of first string of said remote control function match characters of one of remote control functions in a current remote control selection and then reading parameter following said characters of first string of said remote control function;
choosing and implementing said remote control setup procedure corresponding to said characters of first string of said remote control function after determining that said parameter is valid, then;
sending a message to confirm the success of the setting up back to said mobile phone while said remote control setup procedure succeeds.

6. The method as recited in claim 5, wherein, while said another mobile phone determines that said characters of first string are invalid and are the last remote control function in said remote control selection, then said another mobile phone processes the SMS message according to normal SMS routine.

7. The method as recited in claim 6, wherein, while said another mobile phone determines that said characters of first string are not the last remote control function in said remote control selection, said another mobile phone reads next remote control function and the parameter following said characters of first string of said remote control function.

8. The method as recited in claim 5, wherein, while said another mobile phone determines that the parameter is not valid according to said remote control function, then sending a message of error parameter installation back to notify said mobile phone.

9. The method as recited in claim 5, wherein, while said another mobile phone determines that said corresponding function fails to be set up, then sending a message of failure parameter installation back to notify said mobile phone.
